(19) United States
(12) Patent Application Publication
(10) Pub. No.: US 2005/0169801 A1
(43) Pub. Date: Aug. 4, 2005

(54) Autosampler carousel

(76) Inventors: Marilyn Fogel, Washington, DC (US); Matthew Wooler, Washington, DC (US); Bert Collins, Washington, DC (US)

Correspondence Address: MORGAN LEWIS & BOCKIUS LLP, 1111 PENNSYLVANIA AVENUE NW, WASHINGTON, DC, 20004, US

(21) Appl. No.: 10/507,938

(22) PCT Filed: Mar. 13, 2003
(86) PCT No.: PCT/US03/07482

Related U.S. Application Data
(60) Provisional application No. 60/364,046, filed on Mar. 15, 2002.

(51) Int. Cl. G01N 35/00

(52) U.S. Cl. 422/64; 436/43

(57) ABSTRACT

An autosampler loading apparatus (100). The apparatus has an annular base plate (112) with a number of through holes (124) that correspond to the locations of autosampler sample wells (106). An annular upper plate (120) is fixedly secured to the base plate (112), and has through holes (106) that provide storage wells for autosampler samples. A solid rotating plate (118) having only a single hole (132) is installed between the base and upper plates. When in operation, samples are loaded into the apparatus by placing them in the holes (106) in the upper plate (120). The samples are successively loaded into the autosampler when the user rotates the rotating plate (118), allowing the samples to drop from the upper plate (120), through the rotating (118) and base plates, and into the autosampler. A cover (122) is provided for the upper plate, allowing samples to be stored in the apparatus indefinitely.

This application claims the benefit of U.S. Provisional Application No. 60/364,046, filed on Mar. 15, 2002.

### BACKGROUND OF THE INVENTION

1. Field of the Invention

The present invention relates to loading apparatus for scientific instrumentation, and more specifically, to loading apparatus for autosamplers.

2. Description of the Related Art

Elemental analyzers feature as prominent components of many analytical laboratories and produce data that contribute to addressing diverse scientific questions. These machines can be used to analyze the elemental components (e.g. percent carbon and percent nitrogen) and the elemental ratios (e.g. C/N) of a sample. In addition, the stable isotopic composition of a sample can also be determined when the elemental analyzer is attached to a stable isotopic ratio mass spectrometer.

In order to maximize productivity, elemental analyzers are typically fitted with autosamplers. An autosampler is a carousel-type device that has a number of individual wells for various samples. Once a sample analysis run has begun, the autosampler is pneumatically driven to rotate under the control of the elemental analyzer's computer system. As the autosampler rotates, the samples are loaded one-by-one into the analyzer. A device of this type is described in U.S. Pat. No. 4,351,193.

Preparing samples for elemental analysis is generally tedious, labor-intensive, and time-consuming. The final stage of preparation typically involves weighing each sample and placing it in a tin or silver capsule, which is then crimped into a small ball. At this stage of preparation, all samples are apparently identical. Many laboratories with elemental analyzers use cell culture cluster (CCC) trays or individual microcentrifuge tubes for storing samples that have been weighed into tin capsules.

Although functional, these conventional approaches to storing prepared samples have significant disadvantages. For example, the CCC tray consists of a series of wells in rows and columns. Columns are generally numbered 1-12, while the rows are labeled A-F. This is a non-intuitive numbering scheme, because the sample wells of the autosampler are typically labeled as 1-50. Moreover, the traditional storage techniques require two transfer operations with forceps before samples can be loaded into the autosampler. The first stage transfer operation involves placing each sample into a container. The second stage transfer operation involves removing the samples from their temporary container and placing them in the autosampler.

Given the large number of samples that are typically analyzed in any one run, the conventional process for loading samples can result in errors. For example, samples can be dropped when transferring them between a CCC tray and the autosampler. In addition, two samples may accidentally be loaded into the same autosampler position. The samples are visually identical at this stage, and once mixed, the two samples may both need to be discarded. Another potential problem is that the user may miss an autosampler position, which may not compromise the samples, but would require the user to manually re-arrange all of the samples in the autosampler. If all of the samples need to be re-arranged in the autosampler, a very frustrating task, the potential for more errors increases.

### SUMMARY OF THE INVENTION

Autosampler carousels provide the user with an intuitive, transportable, storable means of loading an autosampler. In general, they eliminate the need to use cell culture trays or other intermediate storage devices in the final steps of preparing samples for use with an autosampler and associated analytical machinery. These and other aspects of the invention will be described in greater detail below, and one skilled in the art will appreciate that modifications, variations and changes could be made to the aspects of the invention that are presented.

One aspect of the present invention relates to an apparatus for loading an autosampler. The apparatus includes a base plate, an upper plate, and a rotating plate. The base plate has at least one passage.

The upper plate is constructed and adapted to be connected to the base plate. The upper plate has at least one passage, the passage of the upper plate corresponding substantially to the passage in the base plate.

The rotating plate is constructed and adapted to be inserted between the base plate and the upper plate and to rotate about an axis when interposed between the base and upper plates. The rotating plate has at least one drop hole. The drop hole is positioned and arranged to allow a sample to pass from a passage in the upper plate into a corresponding passage in the base plate.

A second aspect of the present invention relates to an apparatus for loading an autosampler. The apparatus includes a base plate, an upper plate, and a rotating plate. The base plate has a number of passages. The passages in the base plate are adapted and arranged to correspond substantially to sample wells provided in the autosampler. The base plate also includes a mating flange attached to an inner perimeter portion. The mating flange extends from the base plate, and has locking wings on a portion.

The upper plate in this second aspect is constructed and adapted to be inserted onto the mating flange of the base plate. The upper plate has a number of passages, the number of passages in the upper plate corresponding substantially to the number of passages in the base plate. The upper plate also has cooperating locking structures constructed and adapted to engage the locking wings to connect the upper plate to the base plate.

The rotating plate in the second aspect is constructed and adapted to be positioned between the upper plate and the base plate and to rotate about an axis between the two plates. It includes a handle grippable by a user to rotate the rotating plate. The rotating plate also has at least one drop hole. The drop hole is constructed and adapted to allow a sample to pass from a passage in the upper plate to a corresponding passage in the base plate.

A third aspect of the present invention relates to a way to load samples into an autosampler. It comprises providing an autosampler loading apparatus as described above and loading prepared samples into the apparatus. Once the samples are loaded, the user may store the loaded apparatus for a period of time before installing the apparatus on an autosampler and actuating the apparatus to dispense samples into sample wells provided in the autosampler. Once the samples are dispensed, the loading apparatus may be cleaned.

A fourth aspect of the present invention relates to an autosampler loading apparatus. The apparatus includes adapting means, sample storage means, and selectable dispensing means. The adapting means are provided for allowing the apparatus to operationally engage an autosampler. The adapting means include passage means for allowing at least one sample to pass from the apparatus into the autosampler. The adapting means optionally includes centering means for operationally positioning the adapting means in a desired position. The sample storage means are provided for storing autosampler samples. The selectable dispensing means are provided for selectably dispensing the autosampler samples from the sample storage means into the passage means of the adapting means.

### BRIEF DESCRIPTION OF THE DRAWINGS

Embodiments of the present invention will be described with reference to the following Figures, in which like numerals represent like features throughout the several views, and in which:

FIG. 1 is a perspective view illustrating an autosampler carousel according to one embodiment of the present invention installed atop an autosampler;

FIG. 2 is a plan view of the autosampler carousel of FIG. 1;

FIG. 3 is an exploded perspective view of the autosampler carousel of FIG. 1, illustrating the assembly thereof;

FIG. 4 is a cross-sectional view of the autosampler carousel of FIG. 1 through Line 44 of FIG. 2, illustrating a single sample being loaded into a sample well of the autosampler carousel;

FIG. 5 is a cross-sectional view of the autosampler carousel of FIG. 1 through Line 5-5 of FIG. 2, illustrating a single sample resting in a sample well;

FIG. 6 is a cross-sectional view of the autosampler carousel of FIG. 1 through Line 6-6 of FIG. 2, illustrating the sample being loaded into the autosampler following a rotational movement of the central disk;

FIG. 7 is a cross-sectional view of the autosampler carousel of FIG. 1 through Line 7-7 of FIG. 2, illustrating an open sample well of the autosampler carousel after a sample has been loaded into the autosampler; and

FIG. 8 is a high-level flow diagram of a method according to the present invention.

### DETAILED DESCRIPTION

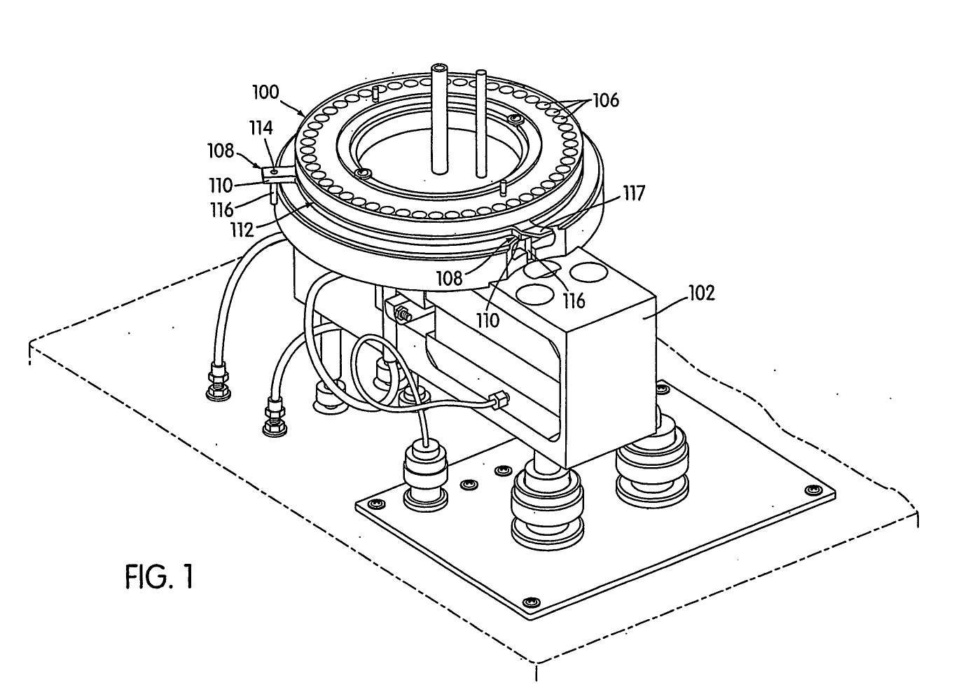

Referring now more particularly to the Figures, FIG. 1 thereof illustrates an autosampler carousel, generally indicated at 100, according to one embodiment of the present invention. The autosampler carousel 100 is shown as installed atop an autosampler 102 in order to illustrate certain of its features, although the autosampler 102 is not part of the present invention. As described above, the autosampler 102 provides automatic sample loading for a chemical or elemental analysis machine, which is not shown in FIG. 1.

The autosampler carousel 100 has a generally annular shape such that it is constructed and arranged to be positioned atop the autosampler 102, once the cover of the autosampler 102 has been removed, to effect sample loading. The autosampler carousel 100 provides a number of sample wells 106 evenly spaced around its perimeter, each of the sample wells 106 having sufficient diameter and depth to accept and hold a sample prior to loading into the autosampler 102. The number, dimensions, and placement of the sample wells 106 may be arbitrarily selected, but are generally chosen so as to coincide with the position, number, and dimensions of the sample wells provided in the autosampler 102.

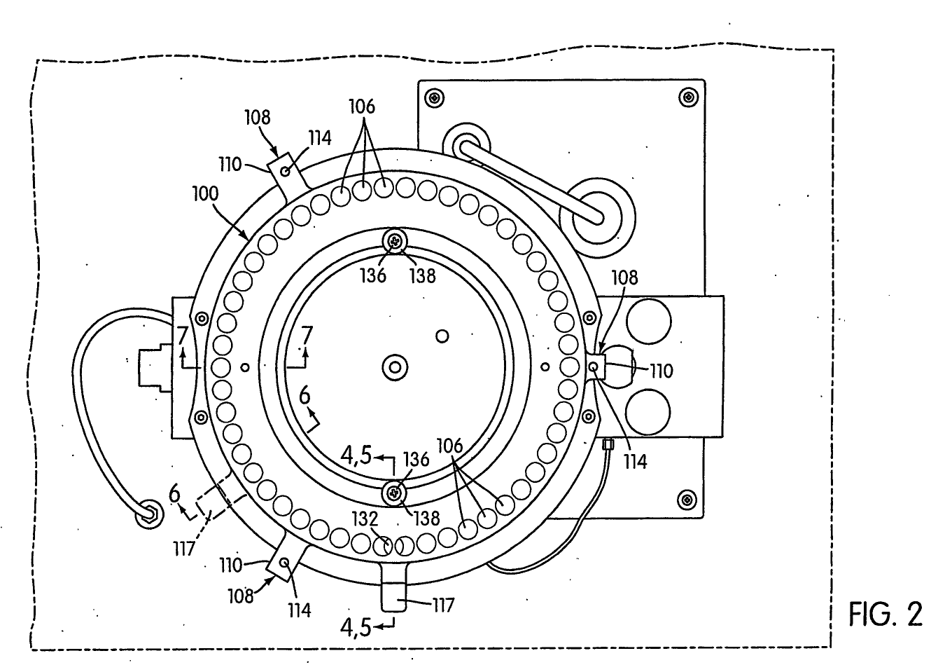

As shown in FIGS. 1 and 2, the autosampler carousel 100 has three positioning projections 108 that assist the user in positioning and centering the autosampler carousel 100 atop the autosampler 102. The positioning projections 108 are comprised of flattened rectangular bars 110 that project from the outer edge of the base 112 of the autosampler carousel 100 to a position beyond the edge of the autosampler 102. A hole 114 is formed in each of the flattened rectangular bars 110 at a position proximate to the edge of the autosampler 102. Installed in and projecting downward from the hole 114 is a centering post 116. The centering post 116 and hole 114 are arranged such that the centering post 116 abuts the outer edge of the autosampler 102 when the autosampler carousel 100 is properly centered on the autosampler.

The centering post 116 may be installed in the hole 114 by any convenient means, such as adhesives, an interference fit, soldering or welding. In one embodiment, the hole 114 is threaded and an upper portion of the centering post 116 has corresponding screw threads, allowing the centering post 116 to be secured in the hole 114 by the cooperating threads of the two components 114, 116.

Once installed on the autosampler 102 and properly centered, the autosampler carousel 100 allows the samples stored in the sample wells 106 to be individually and successively loaded into the corresponding sample wells of the autosampler 102 by a rotational movement of the loading handle 117. In FIG. 2, the loading handle 117 is drawn in phantom to illustrate this loading movement. Because of the position and construction of the autosampler carousel 100, no forceps-type transfer operation is required between the sample wells 106 of the autosampler carousel 100 and the corresponding sample wells of the autosampler 100 itself. The method of operation of the autosampler carousel 100 will be described in greater detail below.

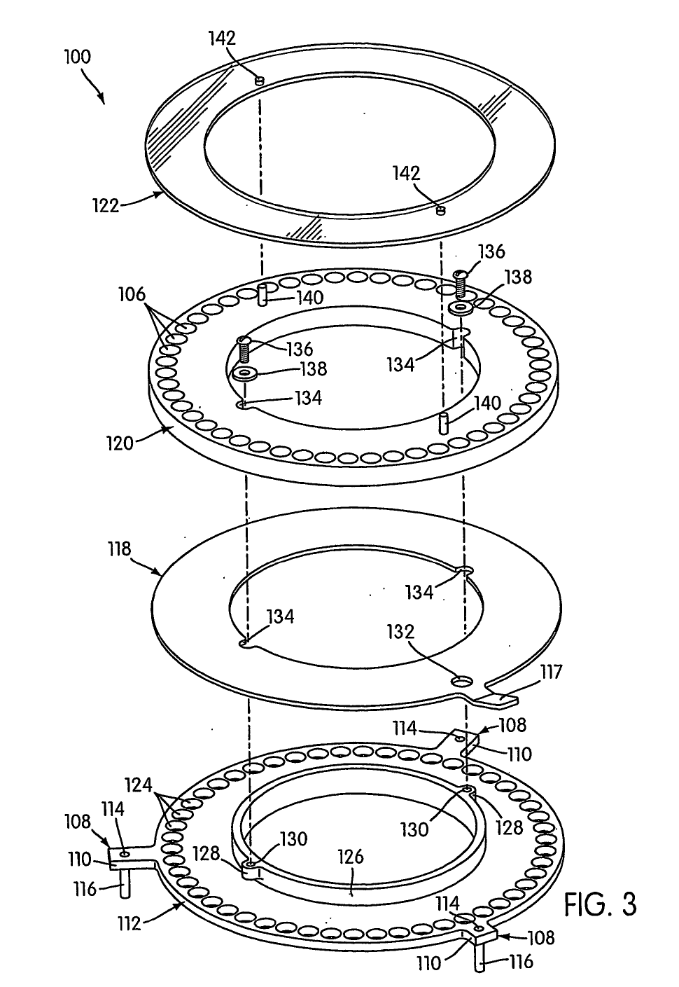

The construction and assembly of the autosampler carousel 100 are best illustrated in FIG. 3, an exploded perspective view of the various components. As shown in FIG. 3, the autosampler carousel 100 is comprised of four major components: a base plate 112, a rotating plate 118, an upper plate 120, and a carousel cover 122.

The base plate 112 forms the base of the assembled autosampler carousel 100. In general, the base plate 112 is an annular plate having the three positioning projections 108 evenly spaced around its edge. Evenly spaced around the perimeter of the base plate 112, and extending through its thickness, are holes 124 corresponding to each of the plurality of sample wells 106 provided in the upper plate 120.

At its inner perimeter, the base plate 112 forms a vertically extending mating collar 126. The mating collar 126 is a central flange onto which the other three components of the autosampler carousel 100 are mounted. As shown, the mating collar 126 has two horizontally extending wings 128 formed opposite one another. The tops of the wings 128 in the illustrated embodiment are even with the top of the mating collar 126. However, the wings 128 have a height that is only a portion of the height of the mating collar 126, leaving the bottom portion of the mating collar 126, the portion beneath the wings 128, without any type of protuberance. Each wing 128 has a threaded hole 130 formed therein, the threaded hole 130 extending from the top surface of the wing 128 downward, parallel with the height of the wing 128.

The wings 128 allow the upper plate 120 to be connected to the base plate 112, while allowing the rotating plate 118 to rotate freely with respect to the other components.

The rotating plate 118 is a substantially solid thin annular plate having only one hole 132 in its perimeter. The rotating plate also includes two semicircular cut-outs 134 that correspond in shape and position to the wings 128 of the base plate 112. When the autosampler carousel 100 is assembled, the rotating plate 118 is placed on the base plate 112. During assembly of the autosampler carousel 100, the semicircular cut-outs 134 allow the rotating plate 118 to pass over the wings 128. When in place, the rotating plate 118 is thin enough so that it rests on the base plate 112 beneath the wings 128, is not engaged by the wings 128, and is thus free to rotate with respect to the base plate 112.

The upper plate 120 is placed on top of the rotating plate 118. It includes semicircular cut-outs 134, similar to those on the rotating plate 118, which engage the wings 128 of the mating collar 126, forming a male-female connection and preventing the upper plate 120 from moving relative to the base plate 112. The upper plate 120 is then secured in place by means of two machine screws 136 and corresponding washers 138 that are positioned over the engaged semicircular cut-outs 134 and wings 128 such that the machine screws 136 extend into the threaded holes 130 in the wings 128.

The upper plate 120 includes two vertical positioning posts 140 located opposite one another on its top surface. The carousel cover 122, a simple annular plate, has two corresponding through holes 142. When the carousel cover 122 is installed on the upper plate 120, the positioning posts 140 of the upper plate 120 extend through the corresponding through holes 142 of the carousel cover 122, fixing the carousel cover 122 in place. The carousel cover 122 may be further secured by means of washers, clamps, or other conventional means. When in place, the carousel cover 122 protects the samples within the autosampler carousel 100, i.e., it prevents samples from falling out of the autosampler carousel 100 and prevents contamination by dust, spilled liquids and other common contaminants.

According to one embodiment of the invention, the base plate 112, rotating plate 118, and upper plate 120 are made of a metal, while the carousel cover 122 is made of a transparent material. Aluminum is one particularly suitable material for the base plate 112, rotating plate 118 and upper plate 120, as it is lightweight, easy to machine, and does not corrode. An oxide layer formed on aluminum shortly after its exposure to air forms a durable barrier, preventing it from reacting with most types of samples.

The metal components may also be formed of another commonly-machined metal such as brass, titanium, magnesium, or stainless steel. In general, the particular metal of which the three metallic components are formed should be selected such that it is non-reactive with the types of samples that are to be placed in the autosampler carousel 100. For example, plain steel may not be a preferred material for some autosampler carousels 100 because of its tendency to corrode and rust on contact with aqueous liquids.

The transparent material that comprises the carousel cover 122 may be glass, a poly(methyl methacrylate) (PMMA)-based polymer, or another organic or inorganic transparent material. Preferably, the material of the carousel cover 122 is such that it may be erasably written upon with a marking medium, as will be described in greater detail below.

According to another embodiment of the invention, plastics (transparent or not) may be used for all of the components of the autosampler carousel 100. However, many of the analyses performed by elemental analyzers include measurements of the carbon content of the respective samples. Because plastics are usually comprised of long chains of carbon atoms, their use in autosampler carousel components creates some risk of contaminating the samples. Therefore, plastics are most advantageously employed for components such as the carousel cover 122, which does not contact the samples.

In one embodiment of the invention, the base plate 112 and upper plate 120 are machined from 0.5 cm thick aluminum sheet, while the rotating plate 118 is machined from 0.05 cm aluminum sheet. In this embodiment, the carousel cover 122 is made from 0.3 cm thick poly(methyl methacrylate) polymer and the base plate 112 and upper plate 120 each have 50 holes.

The components of the autosampler carousel 100 may be manufactured by a number of known and conventional methods, such as machining from stock materials, stamping, casting, and injection molding.

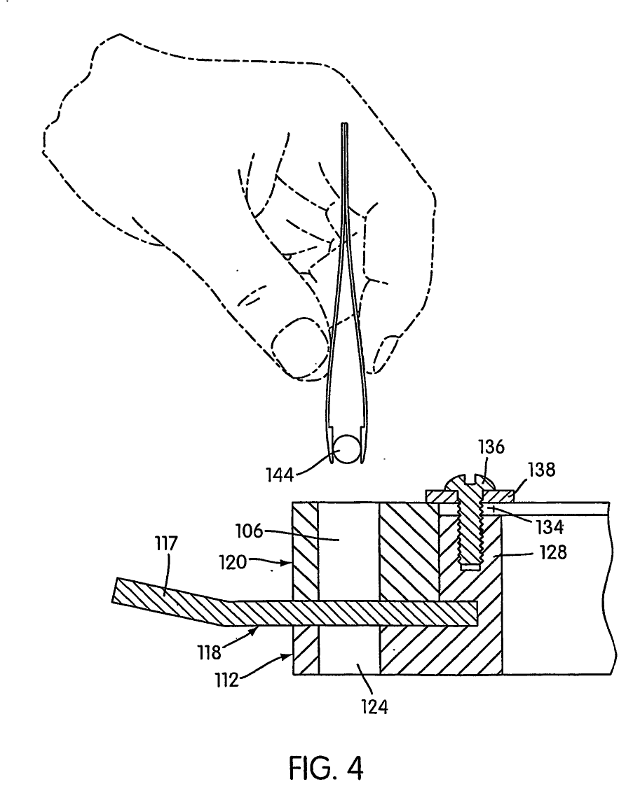

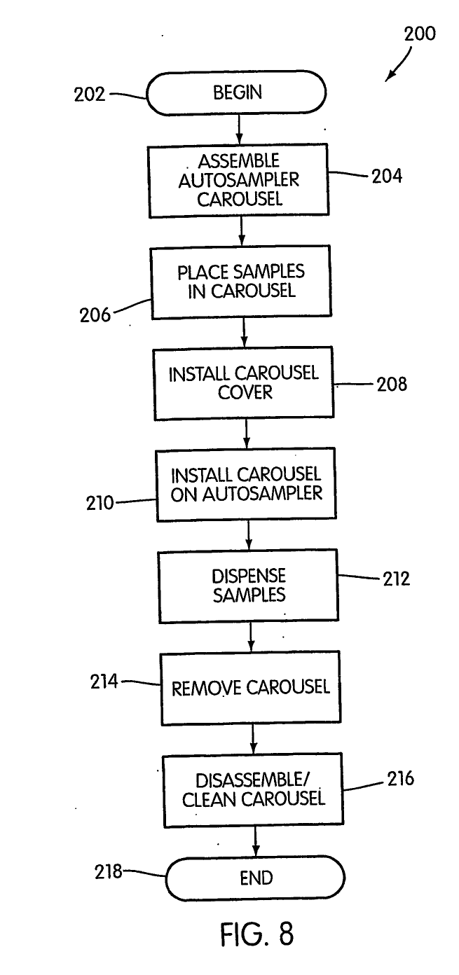

Certain principles of operation of the autosampler carousel 100 are best described with reference to its typical method of use. A method 200 of using the autosampler carousel 100 is illustrated in the cross-sectional views of FIGS. 4-7 and in the flow diagram of FIG. 8. In FIG. 8, method 200 begins at block 202, and continues with block 204. In block 204, the user assembles the autosampler carousel 100 and positions it near standard laboratory sample preparation equipment.

Method 200 continues with block 206. In block 206, the user weighs the samples and places them in individual capsules. As each sample is prepared in block 206, the user places one sample capsule in each of the sample wells 106 of the upper plate 120. Alternatively, the user may use only a few of the sample wells 106, or may select particular sample wells 106 in accordance with a predetermined placement scheme. In order to assist the user with this function, the individual sample wells 106 in the autosampler carousel 100 may be numbered, for example, by engraving a number in the upper plate 120 proximate to each sample well 106.

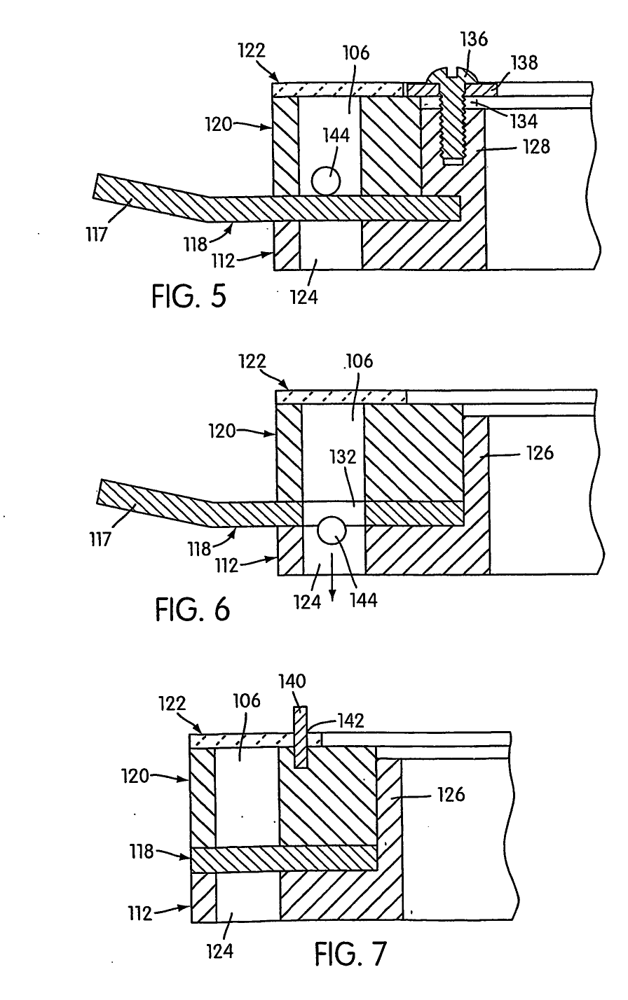

FIG. 4, a cross-sectional view of the autosampler carousel 100 through Line 4-4 of FIG. 2, illustrates the activity of block 206 more clearly. When the user drops the sample capsule 144 into a sample well 106 of the upper plate 120, the rotating plate 118, whose hole 132 is not aligned with the sample well 106, prevents the sample capsule 144 from falling through the holes 124 in the base plate 112 and into the autosampler 102. The resting position of the sample capsule 144 is illustrated in the cross-sectional view of FIG. 5. In FIG. 5, the carousel cover 122 is shown installed over the top of the sample well 106.

Method 200 continues with block 208. In block 208, the user places the carousel cover 122 on the autosampler carousel 100, and optionally, stores the covered autosampler carousel 100 for some length of time. This allows the user to store a prepared collection of samples until the analysis machine becomes available. By storing and transporting a prepared collection of samples in the autosampler carousel 100, the user avoids the disadvantages of storing the samples separately, which would require another storage medium and a separate transfer operation with forceps. Additionally, the user may prepare a number of samples, insert those samples into the sample wells 106 of several autosampler carousels 100, and store all of those autosampler carousels 100 so that their samples can be analyzed in turn.

In order to facilitate the storage task of block 208, the user may write on the carousel cover 122 using marker, grease pen, or another medium to identify the particular autosampler carousel 100 and the samples stored therein. Identifying information written on the carousel cover 122 may include the sample type, the date of preparation, the contents of each well, the desired type of analysis, and the operator or user. In general, an autosampler carousel 100 storing prepared samples would be placed in a dessicator or similar type of clean storage environment to prevent sample contamination while awaiting analysis.

Method 200 continues with block 210. In block 210, the user installs the autosampler carousel 100 atop the autosampler 102 using the three positioning projections 108 to ensure that the autosampler carousel 100 is properly positioned.

Method 200 continues with block 212. In block 212, the user rotates the handle 117 of the rotating plate 118. When the hole 132 is rotated into a position beneath one of the sample wells 106, it creates a passage between the sample well 106 and the holes 124 of the base plate 112, causing the sample capsule 144 in that sample well 106 to fall into the autosampler 102. This action is illustrated in FIGS. 6 and 7, which are cross-sectional views of the autosampler carousel 100 through Lines 6-6 and 7-7, respectively, of FIG. 2. In FIG. 6, the hole 132 in the rotating plate 118 has rotated into a position directly beneath the sample well 106 in the upper plate 120. Consequently, the sample capsule 144 falls through the hole 132 in the rotating plate 118, continues falling through the hole 124 in the base plate 112, and lands in the corresponding sample well of the autosampler 102 (not shown in FIGS. 6-7).

Although the passage between the sample well 106 and the holes 124 of the base plate 112 is illustrated in this embodiment as a substantially vertical, linear passage, it is contemplated that the passage may be nonlinear. For example, in another embodiment, a slanted passage could be created by a particularly shaped hole, allowing a sample capsule 144 to fall into a hole 124 that is not directly beneath the hole 132 of the rotating plate 118. Additionally, the sample capsule 114 may not fall directly into the autosampler, rather, it may be carried by the rotating plate 118 for some angular distance before dropping into the autosampler 102.

The rotation of the handle 117 may be in either the clockwise or the counterclockwise direction with respect to the coordinate system of FIG. 2. FIG. 7 illustrates the empty, open sample well 106. Typically, the user rotates the handle 117 through a full 360-degree rotation, causing all of the sample capsules 144 to fall into the autosampler 102. Alternatively, if the autosampler carousel 100 is only partially full, the user may rotate the handle 117 through less than 360 degrees.

Method 200 continues with block 214. In block 214, the user removes the empty autosampler carousel 100 from the autosampler 102 and installs the autosampler cover (not shown). The autosampler 102 is then pressurized with an inert gas, and the analysis procedure proceeds.

Method 200 continues with block 216. In block 216 the user disassembles the autosampler carousel 100 for cleaning. The autosampler carousel 100 may be cleaned by wiping with an appropriate solvent or surfactant, by dry-wiping, or by immersion in an appropriate solvent, with or without ultrasonic agitation. “Appropriate solvents” depend on the nature of the samples being analyzed, and may include polar and non-polar solvents such as water, acetone, ethanol, methyl ethyl ketone, isopropanol, and hydrocarbons such as hexane. Alternatively, if the user believes the autosampler carousel 100 to be sufficiently clean or uncontaminated, he or she may omit the actions of block 216. Method 200 ends at block 218 of FIG. 8.

Some of the advantages of autosampler carousels according to embodiments of the present invention will become clearer from the following Example.

### EXAMPLE

A conventional method for loading an autosampler using CCC trays was compared with a method for loading an autosampler similar to that of method 200. The results show that there is no significant difference between the time taken to load 30 samples into a CCC tray and the time taken to load 30 samples into an autosampler carousel according to the present invention (60 s, ±4). However, there was a significant time savings when loading the samples into the autosampler using the autosampler carousel (CCC tray=175 s, ±27; autosampler carousel=3 s, ±1). This time savings occurred regardless of the experience level of the user. A second test with inexperienced users showed that up to four samples can be lost using the conventional CCC tray loading process.

While the invention has been described above with respect to certain embodiments thereof, it will be appreciated by one skilled in the art that variations and modifications may be made without departing from the spirit and scope of the invention.

1. An autosampler loading apparatus comprising:
a base plate having at least one passage;
an upper plate constructed and adapted to be connected to the base plate, the upper plate having at least one passage; and
a rotating plate constructed and adapted to be positioned between the base plate and the upper plate and to rotate about an axis therebetween, the rotating plate having at least one drop hole, wherein the drop hole is positioned and arranged to allow a sample to pass from a passage in the upper plate into a corresponding passage in the base plate.

2. The apparatus of claim 1, wherein the sample does not pass immediately from the upper plate into the base plate when the drop hole is positioned and arranged to allow the sample to pass.

3. The apparatus of claim 1, further comprising a cover plate constructed and adapted to cover the upper plate.

4. The apparatus of claim 3, wherein the upper plate has at least one protruding post extending from an upper surface thereof, the cover plate has at least one hole corresponding to the at least one protruding post, and the at least one protruding post is constructed and adapted to be inserted into the at least one hole when the cover plate is operationally engaged on the upper plate.

5. The apparatus of claim 1, wherein the base plate further comprises a mating flange connected to an inner perimeter portion thereof and extending therefrom, the mating flange having locking wings on a portion thereof; and wherein the upper plate further comprises cooperating locking structures constructed and adapted to engage the locking wings to connect the upper plate to the base plate.

6. The apparatus of claim 5, wherein the locking wings have a generally semicircular shape and the cooperating locking structures of the upper plate are corresponding semicircular cut-outs.

7. The apparatus of claim 6, wherein the locking wings include threaded holes formed in a top surface thereof and extending downwardly, and wherein the upper plate and the base plate are connected by screws and corresponding washers installed in the threaded holes.

8. The apparatus of claim 1, wherein the base plate includes a plurality of centering structures constructed and adapted to center the base plate on the autosampler, the centering structures being connected to outer perimeter portions of the base plate.

9. An autosampler loading apparatus comprising:
a base plate having at least one passage;
an upper plate constructed and adapted to be connected to the base plate, the upper plate having at least one passage; and
a rotating plate constructed and adapted to be positioned between the base plate and the upper plate and to rotate about an axis therebetween, the rotating plate having at least one drop hole, wherein the drop hole is positioned and arranged to allow a sample to pass from a passage in the upper plate into a corresponding passage in the base plate.

10. The apparatus of claim 9, wherein the sample does not pass immediately from the upper plate into the base plate when the drop hole is positioned and arranged to allow the sample to pass.

11. The apparatus of claim 9, further comprising a cover plate constructed and adapted to cover the upper plate.

12. The apparatus of claim 11, wherein the upper plate has at least one protruding post extending from an upper surface thereof, the cover plate has at least one hole corresponding to the at least one protruding post, and the at least one protruding post is constructed and adapted to be inserted into the at least one hole when the cover plate is operationally engaged on the upper plate.

13. The apparatus of claim 12, wherein
the base plate further comprises a mating flange connected to an inner perimeter portion thereof and extending therefrom, the mating flange having locking wings on a portion thereof; and
wherein the upper plate further comprises cooperating locking structures constructed and adapted to engage the locking wings to connect the upper plate to the base plate.

14. The apparatus of claim 13, wherein the locking wings have a generally semicircular shape and the cooperating locking structures of the upper plate are corresponding semicircular cut-outs.

15. The apparatus of claim 14, wherein the locking wings include threaded holes formed in a top surface thereof and extending downwardly, and wherein the upper plate and the base plate are connected by screws and corresponding washers installed in the threaded holes.

16. The apparatus of claim 9, wherein the base plate includes a plurality of centering structures constructed and adapted to center the base plate on the autosampler, the centering structures being connected to outer perimeter portions of the base plate.

17. The apparatus of claim 16, wherein each of the centering structures includes a horizontally-extending member, the horizontally-extending member extending outwardly from the base plate, and a downwardly-extending member connected to the horizontally-extending member, the downwardly-extending member being constructed and arranged to abut an upper edge of the autosampler.

18. The apparatus of claim 9, wherein the base plate, the upper plate, and the rotating plate are constructed of a substantially non-corroding metal.

19. The apparatus of claim 18, wherein the substantially non-corroding metal is aluminum or aluminum alloy.

20. The apparatus of claim 11, wherein the cover plate is constructed of a transparent material.

21. The apparatus of claim 20, wherein the transparent material is glass or poly(methyl methacrylate).

22. An autosampler loading apparatus comprising:
a base plate having
a number of base plate passages, the number of base plate passages being adapted and arranged to correspond substantially to sample wells provided in the autosampler; and
a mating flange connected to an inner perimeter portion of the base plate and extending therefrom, the mating flange having locking wings on a portion thereof;
an upper plate constructed and adapted to be inserted onto the mating flange, the upper plate having
a number of upper plate passages, the number of upper plate passages being adapted and arranged to correspond substantially to the number of base plate passages; and
cooperating locking structures constructed and adapted to engage the locking wings to connect the upper plate to the base plate; and
a rotating plate constructed and adapted to be positioned between the upper plate and the base plate and to rotate about an axis therebetween, the rotating plate having
a handle grippable by a user to rotate the rotating plate; and
at least one drop hole, the drop hole constructed and adapted to allow a sample to pass from one of the number of upper plate passages into one of the number of base plate passages.

23. The apparatus of claim 22, further comprising a cover plate constructed and adapted to cover the upper plate.

24. The apparatus of claim 23, wherein the upper plate has posts extending from an upper surface thereof, and wherein the cover plate has corresponding holes, the posts being constructed and adapted to be inserted into the holes when the cover plate is operationally engaged atop said upper plate.

25. The apparatus of claim 22, wherein the locking wings have a generally semicircular shape and the cooperating locking structures of the upper plate are corresponding semicircular cut-outs disposed in an inner perimeter of the upper plate.

26. The apparatus of claim 25, wherein the locking wings further comprise threaded holes formed in a top surface thereof and extending downwardly, and wherein the upper plate and the base plate are further connected by screws and corresponding washers installed in the threaded holes.

27. The apparatus of claim 22, wherein the base plate further comprises centering structures constructed and adapted to center the base plate on the autosampler, the centering structures being fixedly attached to outer perimeter portions of the base plate.

28. The apparatus of claim 27, wherein each of the centering structures comprises a horizontally-extending member, the horizontally-extending member extending outwardly from the base plate, and a downwardly-extending member connected to the horizontally-extending member, the downwardly-extending member being constructed and arranged to abut an upper edge of the autosampler.

29. The apparatus of claim 22, wherein the base plate, the upper plate, and the rotating plate are constructed of a substantially non-corroding metal.

30. The apparatus of claim 29, wherein the substantially non-corroding metal is aluminum or aluminum alloy.

31. The apparatus of claim 23, wherein the cover plate is constructed of a transparent material.

32. The apparatus of claim 31, wherein the transparent material is glass or poly(methyl methacrylate).

33. A method comprising:
providing an autosampler loading apparatus having
a base plate having at least one passage,
an upper plate constructed and adapted to be connected to the base plate, the upper plate having at least one passage, and
a rotating plate constructed and adapted to be positioned between the base plate and the upper plate and to rotate about an axis therebetween, the rotating plate having at least one drop hole, the drop hole positioned and arranged to allow a sample to pass from the at least one passage in the upper plate into the at least one passage in the base plate;
loading prepared samples into the autosampler loading apparatus;
optionally, storing the loaded autosampler loading apparatus for a period of time;
installing the autosampler loading apparatus on an autosampler;
actuating the autosampler loading apparatus to dispense samples into sample wells provided in the autosampler; and
optionally, cleaning the autosampler loading apparatus.

34. An autosampler loading apparatus, comprising:
adapting means for adapting the apparatus to operationally engage an autosampler, said adapting means having passage means for allowing at least one sample to pass from the apparatus into the autosampler, said adapting means optionally including centering means for operationally positioning the adapting means in a desired position;
sample storage means for storing autosampler samples; and
selectable dispensing means for selectably dispensing the autosampler samples from said sample storage means into the passage means of said adapting means.

35. The apparatus of claim 34, further comprising covering means for covering said sample storage means to protect samples stored therein.
